(19) United States
(12) Patent Application Publication
(10) Pub. No.: US 2021/0172651 A1
(43) Pub. Date: Jun. 10, 2021

(54) ELECTRIC SPACE HEATER

(71) Applicant: Matthew Alfred CROWE, Dongguan (CN)

(72) Inventor: Matthew Alfred CROWE, Dongguan (CN)

(21) Appl. No.: 17/112,440

(22) Filed: Dec. 4, 2020

(30) Foreign Application Priority Data
Dec. 6, 2019 (HK) 19133268.3

(51) Int. Cl. F24H 3/02; F24H 7/00; F24H 9/20

(52) U.S. Cl. CPC F24H 3/022; H05B 3/42; F24H 9/2078; F24H 7/002

(57) ABSTRACT

In a electric space heater, particularly in a relatively low mass portable, freestanding forced circulation air heater, a solid thermal storage element is heated by means of the same electrical heating element used for ordinary output, allowing heat to be stored efficiently and provided later to extend the useful heat output of the heater.

### TECHNICAL FIELD

The present invention relates to electric appliances for space heating, particularly forced circulation air heaters.

### BACKGROUND OF THE INVENTION

Heat storage devices may be used in electric space heaters in order to cover a heat demand with stored heat, for instance, to avoid using electricity when its price is higher. A high thermal storage capacity is needed if heat must be delivered for many hours after the storage has been charged with heat, however more modest amounts of thermal storage may still allow a useful extension of heating operation without consuming electricity, or else may provide advantageous thermal buffering on starting of the heater in colder conditions.

A number of competing requirements influence the design of electric appliances for space heating. Particularly in the case of freestanding, portable heaters and also, but to a lesser extent, those intended for permanent installation, there is a need for a heat storage device which has a low mass, requires little space and yet offers a high storage capacity. Manufacturers have heretofore been unable to meet this need with an optimal solution at a price point that is commercially attractive. It is an object of the present invention to address this need or, more generally, to provide an improved electric space heater.

### SUMMARY OF THE INVENTION

According to one aspect of the present invention there is provided an electric space heater comprising:

a housing;

a fan arranged for drawing ambient air into the housing and ejecting an air stream from an air outlet port in the housing;

at least one electrical heating element in the housing for heating the air stream, and

a solid thermal storage element disposed in or adjacent the air outlet port.

By virtue of the solid thermal storage element in or adjacent the air outlet, this solid thermal storage element can be heated by means of the same electrical heating element used for ordinary output, heat can be stored efficiently and provided later using electric energy, particularly in a relatively low mass portable, freestanding forced circulation air heater.

Preferably a duct is disposed in the housing for bounding the air stream.

Preferably the at least one electrical heating element is disposed in the duct between the fan and the air outlet.

Preferably the at least one electrical heating element is a resistance heating element.

Optionally the solid thermal storage element itself may form the at least one resistance heating element. For instance, electrodes may be arranged at opposite ends of the solid thermal storage element to allow an electric current through the solid thermal storage element.

Preferably solid thermal storage element comprises at least one opening therethrough for the passage of air.

Preferably the solid thermal storage element is substantially coextensive with a cross-sectional area of the air outlet.

Preferably the solid thermal storage element is foraminous.

The solid thermal storage element may be of any suitable solid material, particularly of a material selected from a metal, mineral or ceramic, that is suitable for storing heat at a temperature level of at least about 200° C., and especially about 400° C. In particular, mineral material may comprise cement, magnesium oxide, or a natural stone, such as granite or marble.

Preferably the solid thermal storage element is formed of a ceramic material. When the solid thermal storage element itself forms the resistance heating element the material may be at least partially electrically conductive.

The ceramic may be formed of silicon carbide or aluminium nitride, for thermal conductivity in excess of that of carbon steel.

Preferably both the at least one heating element and the solid thermal storage element extend transversely to the air stream.

The solid thermal storage element may be formed in one piece. The solid thermal storage element may be of, for example, cuboid or prismatic, in particular rectangular prismatic, form. The solid thermal storage element may be formed by extrusion, casting or printing.

Optionally, the solid thermal storage element may be recessed inside the housing and spaced apart from the air outlet. A grill may also extend over the air outlet.

Optionally, the solid thermal storage element may be thermally separated from surfaces exposed on the exterior of the heater by means of at least one insulating layer surrounding the solid thermal storage element. The insulating layer may comprise a ceramic material of low thermal conductivity, or a vacuum insulation layer, for example.

Preferably the electric space heater further comprises a temperature sensor for sensing the temperature of the solid thermal storage element and generating a temperature signal, an illuminated display provided externally on the heater, and a control circuit including a controller that receives the temperature signal and controls operation of the illuminated display to provide a visual indication of the temperature.

Preferably the control circuit is provided with power independently of a circuit providing power to the at least one electrical heating element, so that the visual display may be activated when the heating element is off.

The illuminated display may be disposed at a border of the solid thermal storage element or adjacent the perimeter of the grill.

The illuminated display may flash at a rate proportional to the sensed temperature.

Optionally, the illuminated display comprises a plurality of light emitters. The light emitters may be configured to provide two or more distinct colour outputs. The light emitters means may be activated and deactivated sequentially in response to the temperature signal indicating an increase or decrease in temperature.

Optionally, the control circuit may further comprise an ambient temperature sensor, and the illuminated display indicates a temperature that is a function of both ambient temperature and the temperature of the solid thermal storage element.

The control circuit may further comprise an input device, whereby the visual display is actuated after receiving a user input from the input device.

### BRIEF DESCRIPTION OF THE DRAWINGS

Preferred forms of the present invention will now be described by way of example with reference to the accompanying drawings, wherein:

FIG. 1 is a schematic sectional view through a first embodiment of a heater according to the invention;

FIG. 2 is an enlarged view of the air outlet port of the heater of FIG. 1;

FIG. 3 is an enlarged view of an air outlet port of a second embodiment of a heater according to the invention;

FIG. 4 is an exploded view showing the principal components of a third embodiment of a heater according to the invention, and

FIG. 5 is an exploded view of the fan/heater sub-assembly of FIG. 4.

### DESCRIPTION OF THE EMBODIMENTS

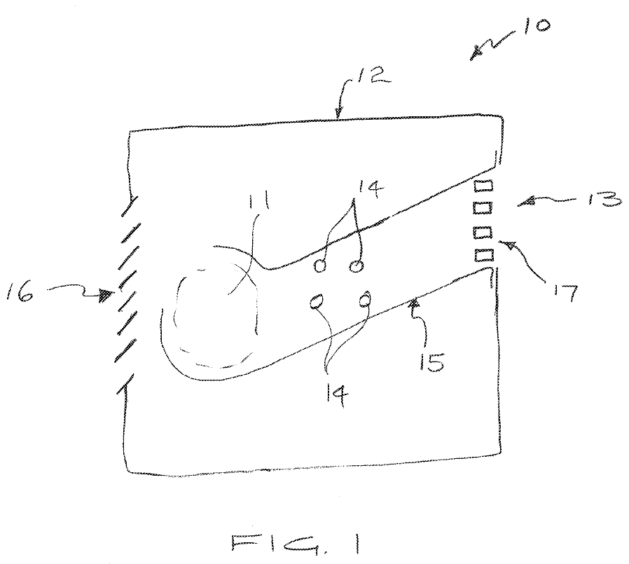

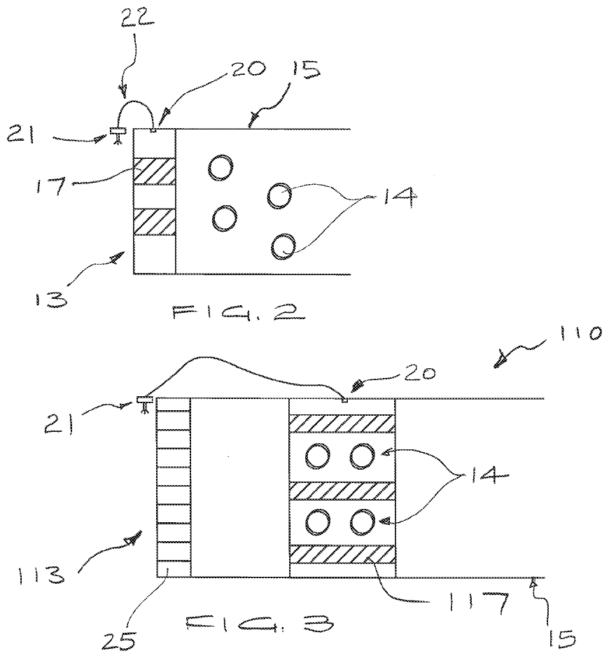

With reference to FIGS. 1 and 2 of the drawings, an electric fan heater 10 of the present invention may include a fan 11 to the rear of a housing 12, and an outlet port 13 on a front of the housing 12.

High-temperature radiant heating elements 14 may be disposed in an air duct 15 leading to the outlet 13 and connected to the outlet of the fan 11.

An intake port 16 in the housing 12 is provided on the intake side of the fan 11.

In a first mode of operation, the fan 11 draws in air through the intake port 16, and at the same time as air begins to be blown into the air duct 15, energization of the radiant heating elements 14 is started.

The radiant heating elements 11 may be of the quartz tube type that heated red hot, to about 700° C. or higher, and when subject to the air stream driven by the fan 11, energy is released to heat the air forced toward the air outlet 13.

A solid thermal storage element 17 may be disposed in the air outlet port 13 and have a foraminous form so as to be quickly charged with heat when the heating elements 11 and fan 11 are operating. The solid thermal storage element 17 provides a second mode in which regenerative heating is performed, allowing continued heat output from the heater after electrical current to the heating elements 11 has stopped. Moreover, the storage element 17 can provide thermal buffering on starting of the heater, while also modulating heat output when the heating elements 11 are cycled on and off.

The heater 10 is thus operated in one of two modes: a first mode in which the fan 11 and heating elements 11 are simultaneously operated while the solid thermal storage element 17 is charged with heat, or its temperature is maintained; and a second mode in which only the fan 11 is operated for heating in which heat is transferred to the air from the solid thermal storage element 17. However, as in the case where the demand slightly exceeds what can be supplied from the solid thermal storage element 17 alone, in a third mode the heating elements 11 may be operated at a low temperature to supplement the heat from the storage element 17.

In the first mode the heating elements 11 may be visible through the air outlet port 13 in the housing, providing an indication to users of the operation of the heater that is not available in the second and third modes. For providing a visual indication of the operation of the heater, particularly in the second and third modes, and preferably in all three modes, the heater may further comprise a temperature sensor 20, such as an NTC thermistor, disposed on the solid thermal storage element 17 for sensing its temperature and generating a temperature signal, an illuminated display 21 provided externally on the heater, and a control circuit 22 including a controller that receives the temperature signal and controls operation of the illuminated display 21.

The illuminated display 21 may comprise a linear array of light emitters, such as LEDs, disposed on or adjacent the outlet port 13

In use, a user may select the operating temperature of the heater 12 by actuating a user control. Initially, all the light emitters of the display are switched off. As the air temperature gradually increases the first light emitter at one end of the display is illuminated in response to the signal received from the sensor 20. As the temperature of the air increases further, an adjacent light emitter is illuminated, so two light emitters are operating. This process continues, each light emitter extending the length of the illuminated array, as the air temperature increases, until all the light emitters are operating. Thus, the light emitters are sequentially activated in response to the temperature signal indicating an increase in temperature. Correspondingly, as the sensor 20 indicates a temperature decrease, illuminated light emitters from one end of the illuminated section of the display are deactivated. In this way, the number of illuminated light emitters is proportional to temperature and Illumination of all of the light emitters in the array indicates a maximum temperature of the solid thermal storage element 17. In particularly preferred embodiments, where the outlet port 13 is generally rectangular, the illuminated display 21 extends adjacent a long edge of the outlet port 13, so as to be readily visible to a user toward whom the air stream from the outlet port 13 is directed.

In addition, for safety, an insulating layer (not shown), as of flock material, may cover the (high temperature) surfaces of the solid thermal storage element 17 that may otherwise be touched by a user.

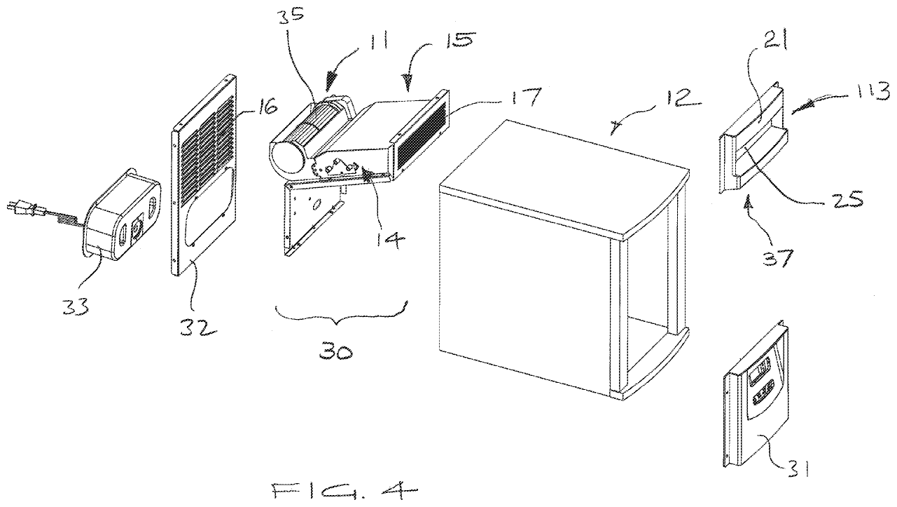

In a second embodiment of the heater 110 shown in FIG. 3, the solid thermal storage element 117 is disposed in the duct 15 adjacent the air outlet port 113, and may be recessed behind a grill 25 that covers the air outlet port 113. The solid thermal storage element 117 is thus inaccessible to users so, still without risking exposing users to a high surface temperature, a higher storage temperature may be maintained without the need for applying an external insulating layer, such as flock material. FIG. 3 also shows an alternative configuration of the solid thermal storage element 117, where the heating elements 14 are disposed in passages extending between opposing transverse sides of the solid thermal storage element 117.

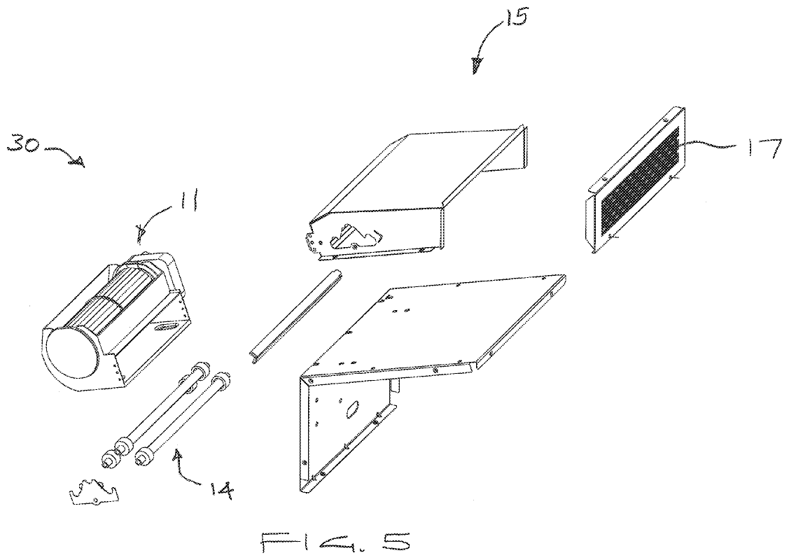

A third embodiment of the invention is shown in FIGS. 4 and 5, and essentially differs from the second embodiment of FIG. 3 in that the solid thermal storage element 17 is downstream, with respect to the air stream induced by the fan 11, from the heating elements 14. The fan 11 may be a part of a subassembly 30 in which the duct 15 generally also provides a structural element by which the fan 11, heating elements 14 and solid thermal storage element 17 are connected.

A front panel 31 may cooperate with an outlet assembly 37 to generally close a front opening in the housing 12, whereas the intake port 16 may be formed in a rear panel 32 in which a power supply 33 is received. The fan 11 may be of the centrifugal type comprising elongate blades 35 disposed parallel to one another in a circular array. The duct 15 may be generally rectangular in cross-section with its long axis parallel to the axes of the blades 35 and inclined to rise toward the outlet assembly 37. Corresponding to the duct 15, the air outlet port 113 may be rectangular. In this embodiment, the air outlet port 113 is covered by the grill 25, so that the solid thermal storage element 17 is recessed behind the grill 25. The illuminated display 21 extends adjacent a long edge of the outlet port 113.

Aspects of the present invention have been described by way of example only and it should be appreciated that modifications and additions may be made thereto without departing from the scope thereof.

1. An electric space heater comprising:
a housing;
a fan arranged for drawing ambient air into the housing and ejecting an air stream from an air outlet port in the housing;
at least one electrical heating element in the housing for heating the air stream, and
a solid thermal storage element disposed in or adjacent the air outlet port.

2. The electric space heater of claim 1 wherein a duct is disposed in the housing for bounding the air stream.

3. The electric space heater of claim 2 wherein the at least one electrical heating element is disposed in the duct between the fan and the air outlet.

4. The electric space heater of claim 3 wherein the at least one electrical heating element is a resistance heating element.

5. The electric space heater of claim 4 wherein the solid thermal storage element comprises at least one opening therethrough for the passage of air.

6. The electric space heater of claim 5 wherein the solid thermal storage element is substantially coextensive with a cross-sectional area of the air outlet.

7. The electric space heater of claim 4 wherein the solid thermal storage element is foraminous.

8. The electric space heater of claim 7 wherein the solid thermal storage element comprises a material selected from a metal, mineral or ceramic, that is suitable for storing heat at a temperature level of at least about 200° C., and especially about 400° C.

9. The electric space heater of claim 7 wherein the solid thermal storage element is formed of a ceramic material.

10. The electric space heater of claim 9 wherein the ceramic is selected from silicon carbide and aluminium nitride.

11. The electric space heater of claim 7 wherein both the at least one heating element and the solid thermal storage element extend transversely to the air stream.

12. The electric space heater of claim 7 wherein the solid thermal storage element is formed in one piece.

13. The electric space heater of claim 12 wherein the solid thermal storage element is of cuboid or prismatic, in particular rectangular prismatic, form.

14. The electric space heater of claim 7 wherein the solid thermal storage element is formed by extrusion, casting or printing.

15. The electric space heater of claim 7 wherein the solid thermal storage element is recessed inside the housing and spaced apart from the air outlet.

16. The electric space heater of claim 15 wherein a grill extends over the air outlet.

17. The electric space heater of claim 7 wherein the solid thermal storage element is thermally separated from surfaces exposed on the exterior of the heater by means of at least one insulating layer surrounding the solid thermal storage element.

18. The electric space heater of claim 7 wherein the electric space heater further comprises a temperature sensor for sensing the temperature of the solid thermal storage element and generating a temperature signal, an illuminated display provided externally on the heater, and a control circuit including a controller that receives the temperature signal and controls operation of the illuminated display to provide a visual indication of the temperature.

19. The electric space heater of claim 18 wherein the control circuit is provided with power independently of a circuit providing power to the at least one electrical heating element, so that the visual display may be activated when the heating element is off.

20. The electric space heater of claim 18 wherein the illuminated display is disposed at a border of the solid thermal storage element or adjacent the perimeter of the grill.

21. The electric space heater of claim 18 wherein the illuminated display comprises a plurality of light emitters.

22. The electric space heater of claim 18 wherein the light emitters are configured to provide two or more distinct colour outputs.

23. The electric space heater of claim 18 wherein the light emitters are activated and deactivated sequentially in response to the temperature signal indicating an increase or decrease in temperature.
